(19) United States
(12) Patent Application Publication
(10) Pub. No.: US 2026/0030882 A1
(43) Pub. Date: Jan. 29, 2026

(54) VIDEO PROCESSING METHOD AND APPARATUS

(71) Applicant: SAMSUNG ELECTRONICS CO., LTD., Suwon-si (KR)

(72) Inventors: Youngchan SONG, Suwon-si (KR); Soomin KANG, Suwon-si (KR); Kwanwoo PARK, Suwon-si (KR); Jaeyeon PARK, Suwon-si (KR); Iljun AHN, Suwon-si (KR); Incheon CHO, Suwon-si (KR)

(73) Assignee: SAMSUNG ELECTRONICS CO., LTD., Suwon-si (KR)

(21) Appl. No.: 19/349,445

(22) Filed: Oct. 3, 2025

Related U.S. Application Data
(63) Continuation of application No. PCT/KR2024/004154, filed on Apr. 1, 2024.

(30) Foreign Application Priority Data
Apr. 5, 2023 (KR) 10-2023-0045038
Mar. 27, 2024 (KR) 10-2024-0041986

(51) Int. Cl. G06V 10/82; G06V 10/62; G06V 10/72; G06V 10/77; G06V 10/776; G06V 20/40

(52) U.S. Cl. CPC G06V 10/82; G06V 10/62; G06V 10/72; G06V 10/7715; G06V 20/46; G06V 10/776

(57) ABSTRACT

Provided is a method of processing a video. The method includes obtaining first feature data from a first frame; obtaining one or more second feature data from one or more second frames, obtaining one or more pieces of bi-directional motion information respectively corresponding to one or more frame pairs, obtaining one or more third feature data by performing first feature processing respectively on one or more feature pairs based on the one or more pieces of bi-directional motion information, obtaining one or more fourth feature data by performing second feature processing on the one or more third feature data based on the one or more pieces of bi-directional motion information, obtaining fifth feature data, based on the first feature data and the one or more fourth feature data, and generating a third frame based on the fifth feature data.

### CROSS-REFERENCE TO RELATED APPLICATIONS

This application is a continuation of International Application No. PCT/KR2024/004154 designating the United States, filed on Apr. 1, 2024, in the Korean Intellectual Property Receiving Office and claiming priority to Korean Patent Application No. 10-2023-0045038, filed on Apr. 5, 2023, in the Korean Intellectual Property Office, Korean Patent Application No. 10-2024-0041986, filed on Mar. 27, 2024, in the Korean Intellectual Property Office, the disclosures of each of which are incorporated by reference herein in their entireties.

### BACKGROUND

### 1. Field

The present disclosure relates to a method and apparatus for processing

a video by using an artificial neural network.

### 2. Description of Related Art

As data traffic has increased exponentially with the development of computer technology, artificial intelligence (AI) technology has become an important trend driving future innovations. Because AI technology simulates human thinking, it is infinitely applicable to virtually all industries. Representative examples of Al technology include pattern recognition, machine learning, expert systems, artificial neural networks, natural language processing, etc.

Artificial neural networks model the characteristics of human biological nerve cells by using mathematical expressions, and use algorithms that mimic human learning abilities. Through these algorithms, the artificial neural networks are able to generate mapping between input data and output data, and the ability to generate such mapping may be referred to as the learning capability of an artificial neural network. Furthermore, neural networks have a generalization ability to generate, based on training results, correct output data with respect to input data that was not used during training.

An artificial neural network may be used for video processing. In particular, the artificial neural network may be used to remove noise or artifacts from video or increase the resolution of the video. Each frame that constitutes a video may contain information that appears repeatedly (e.g., objects, lines, or edges that are identical or similar in size, shape, and/or structure), and such repetitive information may be usefully used when processing the video. In addition, because adjacent frames in a video contain information about changes in time, common repetitive information may appear in the adjacent frames. Therefore, there is a need for a method capable of effectively and efficiently utilizing common repetitive information in adjacent frames during video processing.

### SUMMARY

According to an aspect of the disclosure, there is provided a method of processing a video, the method including: obtaining first feature data from a first frame; obtaining one or more second feature data from one or more second frames; obtaining one or more pieces of bi-directional motion information respectively corresponding to one or more frame pairs, wherein each of the one or more frame pairs includes the first frame and a corresponding second frame among the one or more second frames; obtaining one or more third feature data by performing first feature processing respectively on one or more feature pairs based on the one or more pieces of bi-directional motion information, wherein each of the one or more feature pairs includes the first feature data and corresponding second feature data among the one or more second feature data; obtaining one or more fourth feature data by performing second feature processing on the one or more third feature data based on the one or more pieces of bi-directional motion information; obtaining fifth feature data, based on the first feature data and the one or more fourth feature data; and generating a third frame based on the fifth feature data.

The obtaining of the one or more third feature data by performing the first feature processing respectively on the one or more feature pairs based on the one or more pieces of bi-directional motion information may include: warping the one or more second feature data based on the one or more pieces of bi-directional motion information; converting the first feature data and the warped one or more second feature data into patch embeddings, wherein the patch embeddings may include first patch embeddings into which the first feature data is converted and second patch embeddings into which the warped one or more second feature data are converted, and the first patch embeddings and the second patch embeddings each may include a plurality of patches of a predefined size; performing attention on the patch embeddings; and obtaining the one or more third feature data based on a result of the attention.

The performing of the attention on the patch embeddings may include: obtaining a query based on the first patch embeddings; obtaining a key and a value based on the second patch embeddings; calculating a weight based on the query and the key; and applying the weight to the value.

The performing of the attention on the patch embeddings may include: performing first attention on a patch-by-patch basis on a plurality of patches included in the patch embeddings; and performing second attention on a pixel-by-pixel basis on the plurality of patches included in the patch embeddings.

The obtaining of the one or more fourth feature data by performing the second feature processing on the one or more third feature data based on the one or more pieces of bi-directional motion information may include: obtaining one or more transformation parameters based on the one or more pieces of bi-directional motion information; and obtaining the one or more fourth feature data through a predefined transformation operation on the one or more third feature data based on the one or more transformation parameters.

The one or more transformation parameters may include a scale factor and a bias, and the predefined transformation operation may include multiplying the one or more third feature data by the scale factor and adding the bias to a result of the multiplying.

The method may include obtaining sixth feature data by performing third feature processing on the first feature data; and obtaining the fifth feature data, based on the one or more fourth feature data and the sixth feature data.

According to an aspect of the disclosure, there is provided a non-transitory computer-readable recording medium storing one or more instructions which, when executed by at least one processor, cause an electronic device to perform operations including: obtaining first feature data from a first frame; obtaining one or more second feature data from one or more second frames; obtaining one or more pieces of bi-directional motion information respectively corresponding to one or more frame pairs, wherein each of the one or more frame pairs includes the first frame and a corresponding second frame among the one or more second frames; obtaining one or more third feature data by performing first feature processing respectively on one or more feature pairs based on the one or more pieces of bi-directional motion information, wherein each of the one or more feature pairs includes the first feature data and corresponding second feature data among the one or more second feature data; obtaining one or more fourth feature data by performing second feature processing on the one or more third feature data based on the one or more pieces of bi-directional motion information; obtaining fifth feature data, based on the first feature data and the one or more fourth feature data; and generating a third frame based on the fifth feature data.

According to an aspect of the disclosure, there is provided an electronic device including: at least one processor; and memory storing one or more instructions, wherein the one or more instructions, when executed by the at least one processor, cause the electronic device to perform operations including: obtaining first feature data from a first frame, obtaining one or more second feature data from one or more second frames, obtaining one or more pieces of bi-directional motion information respectively corresponding to one or more frame pairs, wherein each of the one or more frame pairs includes the first frame and a corresponding second frame among the one or more second frames, obtaining one or more third feature data by performing first feature processing respectively on one or more feature pairs based on the one or more pieces of bi-directional motion information, wherein each of the one or more feature pairs includes the first feature data and corresponding second feature data among the one or more second feature data, obtaining one or more fourth feature data by performing second feature processing on the one or more third feature data based on the one or more pieces of bi-directional motion information, obtaining fifth feature data, based on the first feature data and the one or more fourth feature data, and generating a third frame based on the fifth feature data.

The obtaining of the one or more third feature data by performing the first feature processing respectively on the one or more feature pairs based on the one or more pieces of bi-directional motion information may include: warping the one or more second feature data based on the one or more pieces of bi-directional motion information; converting the first feature data and the warped one or more second feature data into patch embeddings, wherein the patch embeddings may include first patch embeddings into which the first feature data is converted and second patch embeddings into which the warped one or more second feature data are converted, and the first patch embeddings and the second patch embeddings each may include a plurality of patches of a predefined size; performing attention on the patch embeddings; and obtaining the one or more third feature data based on a result of the attention.

The performing of the attention on the patch embeddings may include: obtaining a query based on the first patch embeddings; obtaining a key and a value based on the second patch embeddings; calculating a weight based on the query and the key; and applying the weight to the value.

The performing of the attention on the patch embeddings may include: performing first attention on a patch-by-patch basis on a plurality of patches included in the patch embeddings; and performing second attention on a pixel-by-pixel basis on the plurality of patches included in the patch embeddings.

The obtaining of the one or more fourth feature data by performing the second feature processing on the one or more third feature data based on the one or more pieces of bi-directional motion information may include: obtaining one or more transformation parameters based on the one or more pieces of bi-directional motion information; and obtaining the one or more fourth feature data through a predefined transformation operation on the one or more third feature data based on the one or more transformation parameters.

The one or more transformation parameters may include a scale factor and a bias, and the predefined transformation operation may include multiplying the one or more third feature data by the scale factor and adding the bias to a result of the multiplying.

The operations further may include: obtaining sixth feature data by performing third feature processing on the first feature data; and obtaining the fifth feature data, based on the one or more fourth feature data and the sixth feature data.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 illustrates a video processing network according to an embodiment of the present disclosure;

FIG. 2 illustrates a feature processing network according to an embodiment of the present disclosure;

FIG. 3 illustrates a multi-frame matching module according to an embodiment of the present disclosure;

FIG. 4 illustrates a feature matching module according to an embodiment of the present disclosure;

FIG. 5 illustrates a transformer layer according to an embodiment of the present disclosure;

FIG. 6 illustrates a first attention module according to an embodiment of the present disclosure;

FIG. 7 illustrates a second attention module according to an embodiment of the present disclosure;

FIG. 8A illustrates an example of an arrangement of a first attention module and a second attention module, according to an embodiment of the present disclosure;

FIG. 8B illustrates an example of an arrangement of a first attention module and a second attention module, according to an embodiment of the present disclosure;

FIG. 9 illustrates a feature transformation module according to an embodiment of the present disclosure;

FIG. 10 illustrates a feature transformation module according to an embodiment of the present disclosure;

FIG. 11 is a flowchart of a video processing method according to an embodiment of the present disclosure; and

FIG. 12 illustrates an electronic device for processing a video, according to an embodiment of the present disclosure.

### DETAILED DESCRIPTION

Throughout the present disclosure, the expression “at least one of a, b or c” indicates only a, only b, only c, both a and b, both a and c, both b and c, all of a, b, and c, or variations thereof.

The terms used in the present disclosure are selected from general terms currently widely used in the art by taking into account functions described in an embodiment, but may vary according to an intention of a technician engaged in the art, precedent cases, advent of new technologies, etc. Furthermore, some particular terms may be arbitrarily selected by the applicant, and in this case, the meaning of the selected terms will be described in detail in the relevant description of the disclosure. Thus, the terms used herein should be defined not by simple appellations thereof but based on the meaning of the terms together with the overall description of the present disclosure.

Although the terms, such as “first”, “second”, etc., may be used herein to describe various elements or components, these elements or components should not be limited by the terms. The terms are only used to distinguish one element or component from another element or component. For example, as used herein, a first element or component may be termed a second element or component without departing from the scope of an embodiment, and similarly, a second element or component may be termed a first element or component.

Furthermore, when a component is referred to as being “connected” or “coupled” to another component, it should be understood that the component may be directly connected or coupled to the other component, but may also be connected or coupled to the other component via another intervening component therebetween. On the other hand, when a component is referred to as being “directly connected” or “directly coupled” to another component, it should be understood that there is no other intervening component therebetween.

Unless the context clearly indicates otherwise, the singular forms “a, “an,” and “the” are to be understood to include a plurality of referents. Thus, for example, reference to “a component surface” may also include reference to one or more of such surfaces.

Singular expressions used herein are intended to include plural expressions as well unless the context clearly indicates otherwise. Terms used herein, including technical or scientific terms, are intended to have the same meaning as commonly understood by one of ordinary skill in the art described herein.

It will be further understood that the terms “comprises” and/or “includes” when used in the present disclosure, specify the presence of stated features, numbers, steps, operations, elements, components, or combinations thereof described herein, but do not preclude the presence or addition of one or more other features, numbers, steps, operations, elements, components, or combinations thereof.

Furthermore, in the present disclosure, for an element referred to as a ‘unit,’ a ‘module,’ or the like, two or more elements may be combined into a single element, or a single element may be divided into two or more elements according to subdivided functions. Furthermore, each element to be described below may further perform, in addition to its main functions, some or all of functions performed by another element, and some of the main functions of each element may be performed entirely by another element.

All functions or operations described herein may be processed by a single processor or a combination of processors. The processor or combination of processors is circuitry that performs processing, and may include circuitry such as an application processor (AP), a communication processor (CP), a graphics processing unit (GPU), a neural processing unit (NPU), a microprocessor unit (MPU), a system on chip (SoC), an integrated chip (IC), and the like.

In the present disclosure, functions related to artificial intelligence (AI) are performed via a processor and a memory. The processor may consist of one or a plurality of processors. In this case, the one or plurality of processors may be a general-purpose processor such as a central processing unit (CPU), an AP, a digital signal processor (DSP), etc., a dedicated graphics processor such as a GPU, a vision processing unit (VPU), etc., or a dedicated AI processor such as an NPU. The one or plurality of processors may process input data according to predefined operation rules or AI model stored in the memory. Alternatively, when the one or plurality of processors are a dedicated AI processor, the dedicated AI processor may be designed with a hardware structure specialized for processing a particular AI model.

The predefined operation rules or AI model are created via a training process. In this case, the creation via the training process means that the predefined operation rules or AI model set to perform desired characteristics (or purposes) are created by training a base AI model based on a large number of training data via a learning algorithm. The training process may be performed on an apparatus itself on which Al is performed according to the present disclosure, or via a separate server and/or system. Examples of a learning algorithm may include, but are not limited to, supervised learning, unsupervised learning, semi-supervised learning, and reinforcement learning.

An AI model may consist of a plurality of neural network layers. Each of the plurality of neural network layers has a plurality of weight values and may perform neural network computations via calculations between a result of computations in a previous layer and the plurality of weight values. The plurality of weight values assigned to each of the plurality of neural network layers may be optimized by a result of training the AI model. For example, the plurality of weight values may be updated to reduce or minimize a loss or cost value obtained in the AI model during a training process. An artificial neural network may include a deep neural network (DNN), and may be, for example, but is not limited to, a convolutional neural network (CNN), a DNN, a recurrent neural network (RNN), a restricted Boltzmann machine (RBM), a deep belief network (DBN), a bidirectional recurrent DNN (BRDNN), or a deep Q-network (DQN).

In the present disclosure, a machine-readable storage medium may be provided in the form of a non-transitory storage medium. In this regard, the term ‘non-transitory storage medium’ only means that the storage medium does not include a signal (e.g., an electromagnetic wave) and is a tangible device, and the term does not differentiate between where data is semi-permanently stored in the storage medium and where the data is temporarily stored in the storage medium. For example, the ‘non-transitory storage medium’ may include a buffer for temporarily storing data.

In the present disclosure, it should be understood that blocks in each flowchart and combinations of flowcharts may be performed by one or more computer programs including computer-executable instructions. The one or more computer programs may be all stored in a single memory, or may be partitioned and stored in a number of different memories.

According to an embodiment, methods according to the present disclosure may be included in a computer program product when provided. The computer program product may be traded, as a product, between a seller and a buyer. The computer program product may be distributed in the form of a machine-readable storage medium (e.g., compact disc ROM (CD-ROM) or distributed (e.g., downloaded or uploaded) on-line via an application store or directly between two user devices (e.g., smartphones). For online distribution, at least a part of the computer program product (e.g., a downloadable app) may be at least transiently stored or temporally generated in a machine-readable storage medium such as a memory of a server of a manufacturer, a server of an application store, or a relay server.

An embodiment of the present disclosure will be described more fully hereinafter with reference to the accompanying drawings so that the one or more embodiments may be easily implemented by one of ordinary skill in the art of the present disclosure. However, the present disclosure may be implemented in different forms and should not be construed as being limited to an embodiment set forth herein.

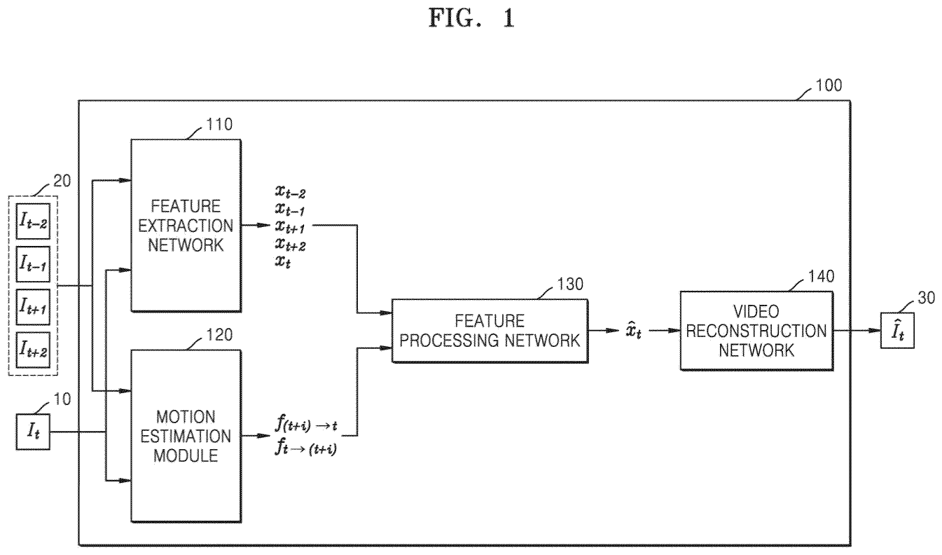

FIG. 1 illustrates a video processing network 100 according to an embodiment of the present disclosure.

Referring to FIG. 1, to process a video, the video processing network 100 may take a first frame 10 and one or more second frames 20 as input, and output a third frame 30. Processing of the video may include, for example, but is not limited to, frame interpolation that generates and inserts a new frame between existing frames, denoising that removes noise such as blur, or super-resolution that converts a low-resolution (e.g., 1920×1080) video to a high-resolution (e.g., 3840×2160) video.

In an embodiment, the first frame 10 is a target frame to be processed. For example, the first frame 10 may be an image containing noise or artifacts, a low-resolution image, or a low-quality image.

In an embodiment, the one or more second frames 20 may be a reference frame used to process the first frame 10. For example, a reference frame may be referred to as an adjacent frame, a surrounding frame, a nearby frame, a neighboring frame, or a close frame. The one or more second frames 20 may include one or more frames that are consecutive to the first frame 10, but do not necessarily refer only to frames that are consecutive to the first frame 10. For example, the one or more second frames 20 may be one or more frames included in the same scene as the first frame 10. In this case, whether the first frame 10 and the one or more second frames 20 are included in the same scene may be identified based on meta information of the video.

In the present disclosure, for convenience of description, as illustrated in FIG. 1, an example is described in which the first frame 10 is a t-th frame I_{.}, and the one or more second frames 20 are a t−2-th frame Iₜ₋₂, a t−1-th frame Iₜ₋₁, a t+1-th frame Iₜ₊₁, and a t+2-th frame. Iₜ₊₂, but the number of the second frames 20 and the order of the first frame 10 and the one or more second frames 20 are not limited thereto. For example, the video processing network 100 may utilize the t−1-th frame and the t+2-th frame as the second frames 20.

In an embodiment, the third frame 30 is a frame generated as a result of the first frame 10 being processed by the video processing network 100. For example, the third frame 30 may be an image from which noise or artifacts are removed from the first frame 10, an image with a higher resolution than the first frame 10, or an image with a higher quality than the first frame 10.

In an embodiment, the video processing network 100 may include a feature extraction network 110, a motion estimation module 120, a feature processing network 130, and a video reconstruction network 140. However, the components of the video processing system 100 are not limited thereto, and the video processing system 100 may not include some of the components illustrated in FIG. 1, and may further include other components in addition to those illustrated in FIG. 1.

In an embodiment, the feature extraction network 110 may extract (e.g., obtain) feature data from the input frames. For example, the feature extraction network 110 may extract first feature data xₜ from the first frame 10, and one or more second feature data xₜ₋₂, xₜ₋₂, and xₜ₊₂ from the one or more second frames 20. The feature extraction network 110 may include one or more CNNs.

In an embodiment, the feature extraction network 110 may be a single network that extracts the first feature data and the one or more second feature data respectively from the first frame 10 and one or more second frames 20.

In an embodiment, the feature extraction network 110 may include a plurality of feature extraction subnetworks corresponding to the first frame 10 and the one or more second frames 10. For example, in the example of FIG. 1, the feature extraction network 110 may include a first feature extraction subnetwork for extracting the first feature data xₜ from the first frame I_{.}, a second feature extraction subnetwork for extracting the second feature data xₜ₋₂ from the second frame Iₜ₋₂, a third feature extraction subnetwork for extracting the second feature data xₜ₋₂ from the second frame Iₜ₋₂, a fourth feature extraction subnetwork for extracting the second feature data xₜ₊₁ from the second frame Iₜ₊₁, and a fifth feature extraction subnetwork for extracting the second feature data xₜ₊₂ from the second frame Iₜ₊₂. In this case, each of the plurality of feature extraction subnetworks may include one or more CNNs.

In an embodiment, the motion estimation module 120 may perform bi-directional motion estimation on an input frame pair. In this case, the frame pair may include the first frame 10 and a corresponding second frame 20 among the one or more second frames 20. For example, in the example of FIG. 1, the motion estimation module 120 may perform bi-directional motion estimation on each of a first frame pair including a t-th frame and a t−2-th frame, a second frame pair including a t-th frame and a t−1-th frame, a third frame pair including a t-th frame and a t+1-th frame, and a fourth frame pair including a t-th frame and a t+2-th frame. In the present disclosure, a result of the bi-directional motion estimation may be referred to as bi-directional motion information.

In an embodiment, bi-directional motion information may include first motion information ƒ_{t→(t+i)} from the first frame 10 to the second frame 20, and second motion information ƒ_{(t+i)→t} from the second frame 20 to the first frame 10. In the example of FIG. 1, i is −2, −1, +1, and +2. For example, the first motion information and the second motion information may include at least one of a vector, coordinates, or a transformation matrix representing a change in position of an object between the first frame 10 and the second frame 20.

In an embodiment, the motion estimation module 120 may be implemented as an artificial neural network model (e.g., a model that predicts an optical flow by using a CNN, a transformer-based model, or the like), or it may be implemented as an algorithm that does not use an artificial neural network (e.g., the Lucas-Kanade method, the Horn-Schunck algorithm, polynomial fitting, the Kalman filter, etc.).

In an embodiment, the feature processing network 130 may process input feature data based on bi-directional motion information. The feature data input to the feature processing network 130 may include the first feature data and the one or more second feature data.

In an embodiment, the feature processing network 130 may obtain third feature data by performing feature processing, including attention, on a feature pair, based on bi-directional motion information. Here, a feature pair may include the first feature data and corresponding second feature data among the one or more second feature data. For example, in the example of FIG. 1, the feature processing network 130 may perform feature processing, including attention, on a first feature pair including the first feature data xₜ and the second feature data xₜ₋₂, a second feature pair including the first feature data xₜ and the second feature data xₜ₋₁, a third feature pair including the first feature data xₜ and the second feature data xₜ₊₁, and a fourth feature pair including the first feature data xₜ and the second feature data xₜ₊₂.

In an embodiment, attention may include operations for obtaining projected feature data, referred to as query, key, and value, based on input feature data, calculating a weight corresponding to a correlation between the query and the key, and applying the weight to the value.

In an embodiment, the feature processing network 130 may obtain fourth feature data by performing feature processing, including feature transformation, on third feature data, based on bi-directional motion information. In this case, the feature transformation may be understood as a process of modulating the corresponding third feature data based on the consistency of the bi-directional motion information between two frames. For example, the feature transformation may include obtaining a scale factor and a bias based on the bi-directional motion information, and transforming the third feature data based on the obtained scale factor and bias.

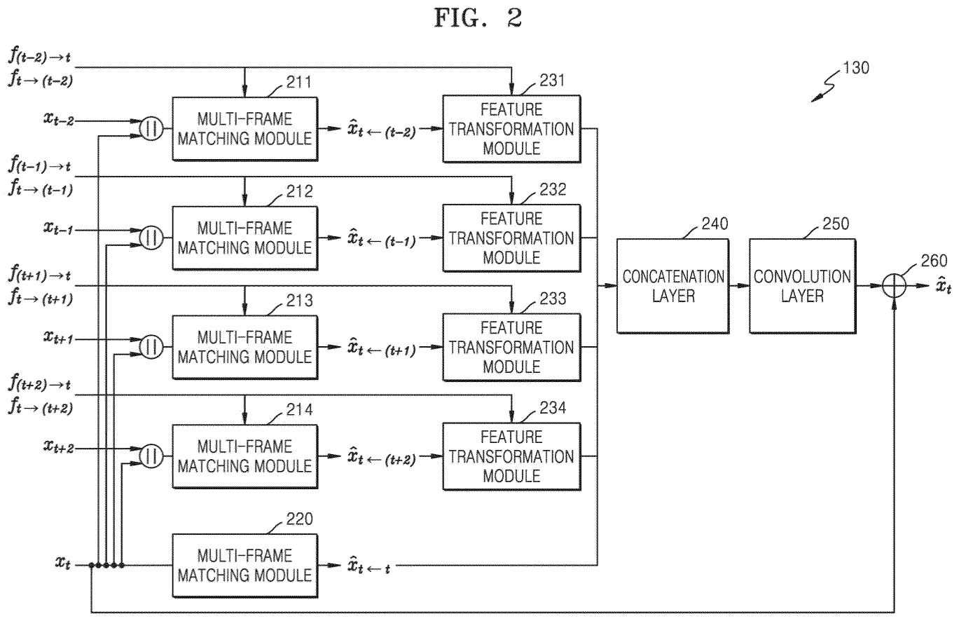

Examples of the structure and operation of the feature processing network 130 are described below with reference to FIGS. 2 to 10.

In an embodiment, the video reconstruction network 140 may generate the third frame 30 based on the input feature data. For example, the video reconstruction network 140 may convert feature data in a feature domain into an image in an image domain. The feature data input to the video reconstruction network 140 may be the fifth feature data \hat{x}ₜ obtained by the feature processing network 130.

The video reconstruction network 140 may be implemented in various ways depending on the application. For example, for super-resolution, the video reconstruction network 140 may include one or more up-convolution layers and one or more pixel shuffle layers. For example, in the case of denoising, the video reconstruction network 140 may include a network based on a Multi-layer Perceptron (MLP).

FIG. 2 illustrates the feature processing network 130 according to an embodiment of the present disclosure.

Referring to FIG. 2, in an embodiment, the feature processing network 130 may include one or more multi-frame matching modules 211, 212, 213, 214, and 220, one or more feature transformation modules 231, 232, 233, and 234, a concatenation layer 240, a convolution layer 250, and a summation layer 260. Although FIG. 2 shows that the feature processing network 130 includes the five multi-frame matching modules 211, 212, 213, 214, and 220 and the four feature transformation modules 231, 232, 233, and 234, this is merely an example, and the number of multi-frame matching modules and the number of feature transformation modules are not limited thereto.

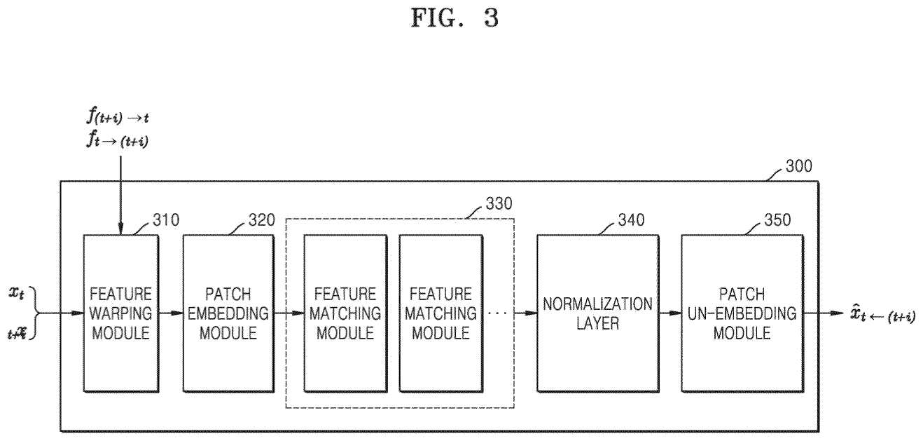

In an embodiment, the one or more multi-frame matching modules 211, 212, 213, 214, and 220 may include first multi-frame matching modules 211, 212, 213, and 214 and a second multi-frame matching module 220. As illustrated in FIG. 2, the first multi-frame matching modules 211, 212, 213, and 214 may perform feature processing respectively on the feature pairs described above, and the second multi-frame matching module 220 may perform feature processing on the first feature data. Therefore, in an embodiment, the feature processing operations of the second multi-frame matching module 220 may be the same as the remaining ones of the feature processing operations of each of the first multi-frame matching modules 211, 212, 213, and 214, other than an operation related to a feature pair (operation of a feature warping module (310 of FIG. 3)). However, the present disclosure is not limited thereto, and for example, the second multi-frame matching module 220 may be implemented in the same manner as the first multi-frame matching modules 211, 212, 213, and 214 to perform feature processing on a feature pair including two first feature data. Therefore, in the following description, the first multi-frame matching modules 211, 212, 213, and 214 and the second multi-frame matching module 220 are described without distinguishing between them.

In an embodiment, each of the multi-frame matching modules 211, 212, 213, 214, and 220 may obtain third feature data by performing feature processing, including attention, on a feature pair, based on bi-directional motion information. Here, the feature pair may include the first feature data and corresponding second feature data among one or more second feature data. For example, a feature pair may be a concatenated matrix of the first feature data and the second feature data.

For example, the multi-frame matching module 211 may obtain third feature data \hat{x}_{t←(t-2)} by performing feature processing on a first feature pair including the first feature data xₜ and second feature data xₜ₋₂ based on bi-directional motion information ƒ_{(t-2)→t} and ƒ_{t→(t-2)} between a t-th frame and a t−2-th frame.

For example, the multi-frame matching module 212 may obtain third feature data \hat{x}_{t←(t-i)} by performing feature processing on a second feature pair including the first feature data xₜ and second feature data xₜ₋₁ based on bi-directional motion information ƒ_{(t-1)→t} and ƒ_{t→(t-1)} between the t-th frame and a t−1-th frame.

For example, the multi-frame matching module 213 may obtain third feature data. \hat{x}_{t←(t+1)} by performing feature processing on a third feature pair including the first feature data xₜ and second feature data xᵢ₊₁ based on bi-directional motion information ƒ_{(t+1)→t} and ƒ_{t→(t+1)} between the t-th frame and a t+1-th frame.

For example, the multi-frame matching module 214 may obtain third feature data \hat{x}_{t←(i+2)} by performing feature processing on a fourth feature pair including the first feature data and second feature data xₜ₊₂ based on bi-directional motion information ƒ_{(t+2)→t} and ƒ_{t→(t+2)} between the t-th frame and a t+2-th frame.

In addition, as described above, the multi-frame matching module 220 may obtain third feature data \hat{x}_{t←t} by performing feature processing on the first feature data xₜ, or obtain the third feature data \hat{x}_{t←t} by performing feature processing on a feature pair including two first feature data xₜ.

Examples of a detailed structure and operation of the multi-frame matching modules 211, 212, 213, 214, and 220 are described below with reference to FIGS. 3 to 8B.

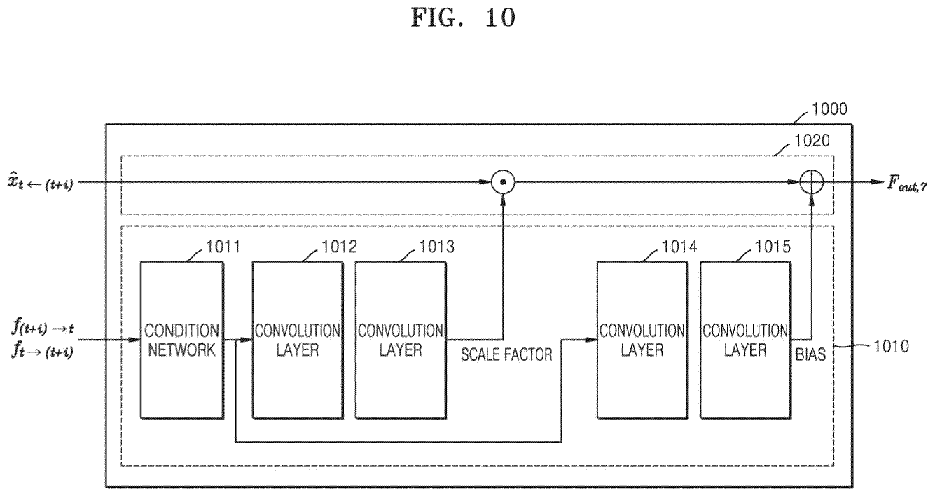

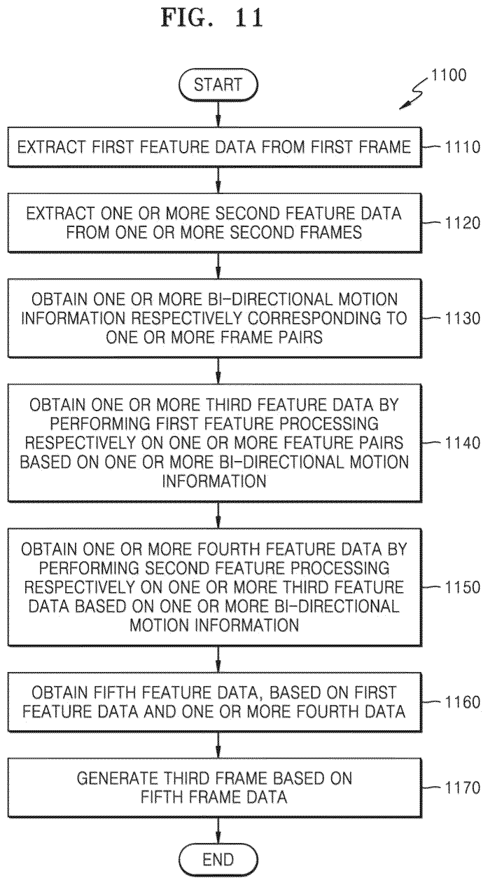

In an embodiment, each of the feature transformation modules 231, 232, 233, and 234 may obtain fourth feature data by applying feature transformation to third feature data based on bi-directional motion information. Examples of the structure and operation of the feature transformation modules 231, 232, 233, and 234 are described below with reference to FIGS. 10 and 11.

In an embodiment, the concatenation layer 240 may concatenate a plurality of input feature data in a channel direction. For example, the feature data input to the concatenation layer 240 may include feature data (e.g., \hat{x}_{t←i}) output from the second multi-frame matching module 220 and feature data output from the feature transformation modules 231, 232, 233, and 234.

In an embodiment, the convolution layer 250 may perform a convolution operation between input feature data and a kernel included in the convolution layer 250. For example, the feature data input to the convolution layer 250 may be feature data output from the concatenation layer 240. Although FIG. 2 shows that the feature processing network 130 includes one convolution layer 250, the number of convolution layers 250 is not limited thereto, and the feature processing network 130 may include two or more convolution layers.

In an embodiment, the summation layer 260 may obtain fifth feature data x by performing an element-wise summation operation between output data from the convolution layer 250 and the first feature data. The fifth feature data may be input to the video reconstruction network (140 of FIG. 1).

FIG. 3 illustrates a multi-frame matching module 300 according to an embodiment of the present disclosure.

The multi-frame matching module 300 illustrated in FIG. 3 may be any one of the multi-frame matching modules 211, 212, 213, 214, and 220 illustrated in FIG. 2.

Referring to FIG. 3, in an embodiment, the multi-frame matching module 300 may obtain third feature data by performing feature processing on a feature pair including first feature data xₜ and second feature data based on bi-directional motion information ƒ_{(t+i)→t} and ƒ_{t→(t+i)} between the t-th frame and the t+i-th frame. In the examples of FIGS. 1 to 3, i is −2, −1, +1, and +2.

In an embodiment, the multi-frame matching module 300 may include the feature warping module 310, a patch embedding module 320, one or more feature matching modules 330, a normalization layer 340, and a patch un-embedding module 350.

In an embodiment, the feature warping module 310 may warp input second feature data based on bi-directional motion information. Here, the warping may include, but is not limited to, similarity transformation, Euclidean transformation, affine transformation, projective transformation, etc. For example, the feature warping module 310 may warp the second feature data so that a position of an element included in the second feature data corresponds to a position of an element in the first feature data, based on coordinates representing a change in a position of an object between the first frame 10 and the second frame 20, which is included in the bi-directional motion information.

Because the first feature data and the second feature data are respectively extracted from different frames, the position of the same object in the first feature data and the second feature data may vary due to movement of the object or movement of a camera. The feature warping module 310 may correct such positional transformation of the object. By warping the second feature data by the feature warping module 310, subsequent operations (e.g., attention, etc.) may be performed robustly to transformation of frames, such as movement of the object.

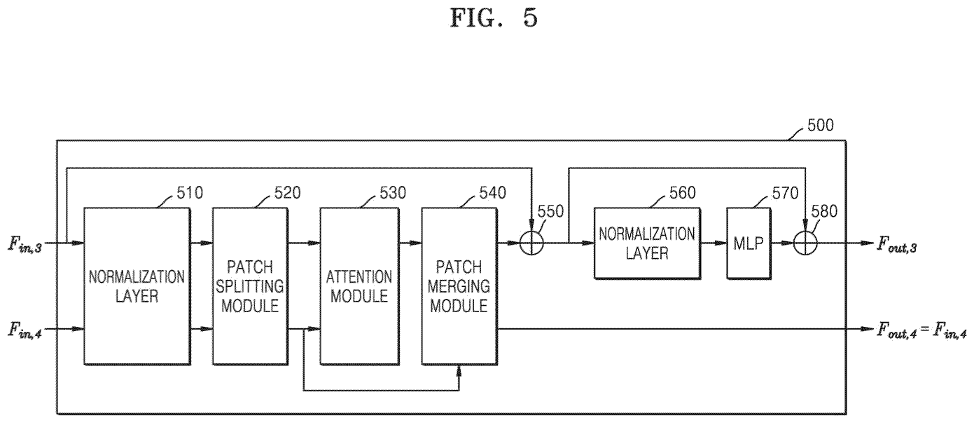

In an embodiment, the operation of the feature warping module 310 may be performed in an attention module (530 of FIG. 5) rather than in the multi-frame matching module 300. Because feature warping is intended to ensure that an attention operation is robust to frame transformation, the feature warping may be performed at any stage, for example, before extracting keys and values from the second feature data.

Moreover, as described above, the second multi-frame matching module (220 of FIG. 2) may be configured not to include the feature warping module 310.

In an embodiment, the patch embedding module 320 may convert input feature data into patch embeddings. For example, the patch embedding module 320 may split the input feature data into a plurality of patches of a predefined size, and obtain patch embeddings by applying a linear transformation to the patches. The feature data input to the patch embedding module 320 may include the first feature data and the warped second feature data. In an embodiment, the patch embeddings may include first patch embeddings obtained from the first feature data and second patch embeddings obtained from the second feature data.

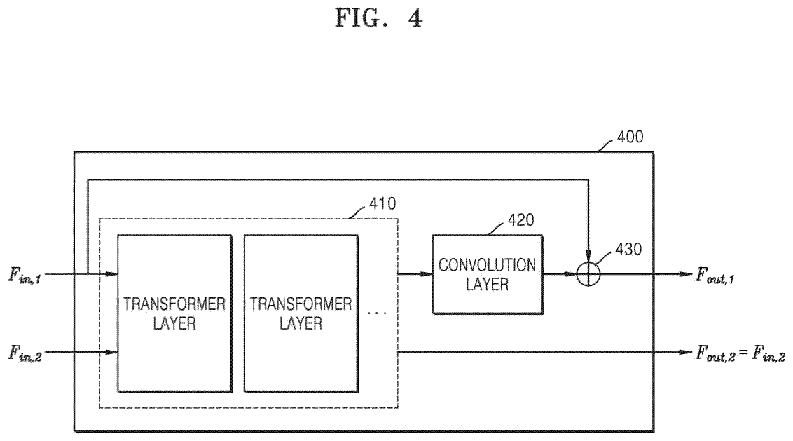

In an embodiment, the one or more feature matching modules 330 may perform feature processing on the input feature data. For example, the data input to the one or more feature matching modules 330 may be patch embeddings obtained by patch embedding modules 320. An example of the structure and operation of the feature matching module 330 is described below with reference to FIG. 4.

In an embodiment, the normalization layer 340 may normalize the input data. For example, the data input to the normalization layer 340 may be normalized so that the sum of the data is 1. However, the normalization method performed by the normalization layer 340 is not limited thereto. The data input to the normalization layer 340 may be data obtained as a result of the feature processing by the one or more feature matching modules 330.

In an embodiment, the patch un-embedding module 350 obtain third feature data \hat{x}_{t←(t+i)} by unembedding the input data. The operation of the patch un-embedding module 350 may be understood as the inverse of the operation of the patch embedding module 320. The data input to the patch un-embedding module 350 may be data obtained as a result of the normalization operation of the normalization layer 340.

FIG. 4 illustrates a feature matching module 400 according to an embodiment of the present disclosure.

The feature matching module 400 illustrated in FIG. 4 may be any one of the one or more feature matching modules 330 illustrated in FIG. 3.

Referring to FIG. 4, in an embodiment, the feature matching module 400 may include one or more transformer layers 410, a convolution layer 420, and a summation layer 430.

In an embodiment, the one or more transformer layers 410 may each perform feature processing on first input data F_{in,1} and second input data F_{in,2}. The first input data F_{in,1} input to the one or more transformer layers 410 may be data obtained as a result of the first feature data xₜ being processed by the feature warping module 310 and the patch embedding module 320. The second input data F_{in,2} input to the one or more transformer layers 410 may be data obtained as a result of the second feature data xₜ₊ᵢ being processed by the feature warping module 310 and the patch embedding module 320. An example of the structure and operation of the one or more transformer layers 410 is described below with reference to FIG. 5.

In an embodiment, a convolution layer 420 may perform a convolution operation between input feature data and a kernel included in the convolution layer 420. For example, the feature data input to the convolution layer 420 may be feature data output from the one or more transformer layers 410. Although FIG. 4 shows that the feature matching module 400 includes one convolution layer 420, the number of convolution layers 420 is not limited thereto, and the feature matching module 400 may include two or more convolution layers.

In an embodiment, the summation layer 430 may obtain first output data F_{out,1} by performing an element-wise summation operation between output data from the convolution layer 420 and the first input data F_{in,1}. The first output data may be input as first input data F_{in,1} for a next feature matching module.

In an embodiment, the feature matching module 400 may output the first output data F_{out,1} and second output data F_{out,2}. The first output data F_{out,1} may be data obtained by the summation layer 430, and the second output data F_{out,2} may be the same as the second input data F_{in,2}.

FIG. 5 illustrates a transformer layer 500 according to an embodiment of the present disclosure.

The transformer layer 500 illustrated in FIG. 5 may be any one of the one or more transformer layers 410 illustrated in FIG. 4.

Referring to FIG. 5, in an embodiment, the transformer layer 500 may include a first normalization layer 510, a patch splitting module 520, an attention module 530, a patch merging module 540, a first summation layer 550, a second normalization layer 560, an MLP 570, and a second summation layer 580.

In an embodiment, the first normalization layer 510 may normalize first input data F_{in,3} and second input data F_{in,4} input to the transformer layer 500. The first input data F_{in,3} input to the transformer layer 500 may be the first input data F_{in,1} input to the one or more transformer layers 410. The second input data F_{in,4} input to the transformer layer 500 may be the second input data F_{in,2} input to the one or more transformer layers 410. The normalized first input data and second input data may be input to the patch splitting module 520.

For example, the first normalization layer 510 may normalize the first input data so that a sum of the first input data input to the transformer layer 500 is 1. The first normalization layer 510 may normalize the second input data so that a sum of the second input data input to the transformer layer 500 is 1. However, the normalization method performed by the first normalization layer 510 is not limited thereto.

In an embodiment, the patch splitting module 520 may split each of the first input data and the second input data input thereto into a plurality of patches of a predefined size. The first input data input to the patch splitting module 520 may be the first input data F_{in,3} normalized by the first normalization layer 510. The second input data input to the patch splitting module 520 may be the second input data F_{in,4} normalized by the first normalization layer 510. In an embodiment, the size of a patch may be determined by considering hardware performance, memory size, etc. For example, the larger the size of patch, the greater the computational cost. In an embodiment, the shape of a patch may be square (i.e., M×M), but is not limited thereto, and may also be rectangular (i.e., M×N).

In an embodiment, the attention module 530 may perform attention on first input data and second input data that are input thereto. The first input data input to the attention module 530 may be patches obtained by normalizing and then splitting the first input data F_{in,3} input to the transformer layer 500. The second input data input to the attention module 530 may be patches obtained by normalizing and then splitting the second input data F_{in,4} input to the transformer layer 500.

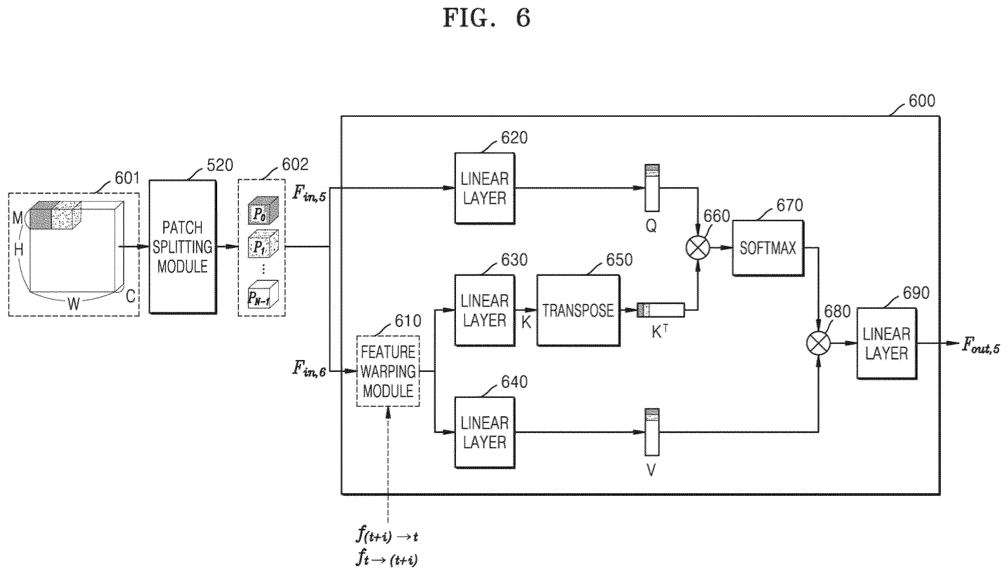

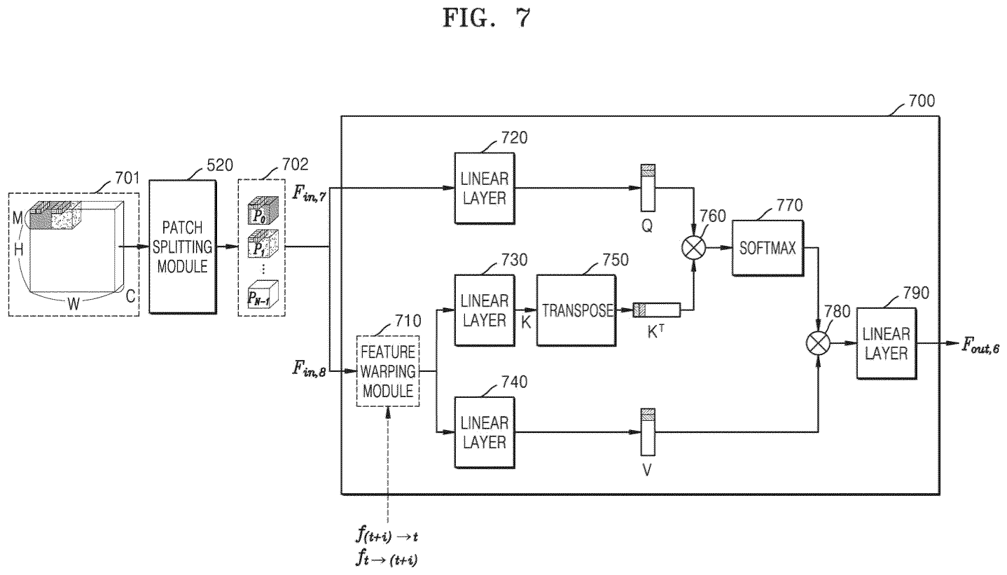

In an embodiment, the attention module 530 may be one of a first attention module (600 of FIG. 6) or a second attention module (700 of FIG. 7). The first attention module 600 may perform attention on each of the patches obtained via splitting by the patch splitting module 520. The second attention module 700 may perform attention on each of the pixels included in each patch. Examples of the structures and operations of the first attention module 600 and the second attention module 700 are described below with reference to FIGS. 6 and 7, respectively.

In an embodiment, the patch merging module 540 may merge first input data input thereto and merge second input data. The operation of the patch merging module 540 may be understood as the inverse of the operation of the patch splitting module 520. The first input data input to the patch merging module 540 may be a result of the attention performed by the attention module 530. The second input data input to the patch merging module 540 may be the second input data input to the attention module 530.

In an embodiment, the first summation layer 550 may perform an element-wise summation operation between first output data from the patch merging module 540 and first input data input to the transformer layer 500. Output data from the first summation layer 550 may be input to the second normalization layer 560.

In an embodiment, the second normalization layer 560 may normalize the output data from the first summation layer 550. For example, the second normalization layer 560 may normalize the output data from the first summation layer 550 so that a sum of the output data from the first summation layer 550 is 1. However, the normalization method performed by the second normalization layer 560 is not limited thereto.

In an embodiment, the MLP 570 may perform feature processing on the data normalized by the second normalization layer 560. The MLP 570 may include one or more fully connected layers and one or more activation functions. For example, the MLP 570 may include a first linear layer, a Gaussian Error Linear Unit (GELU) function, and a second linear layer, wherein the first linear layer and the second linear layer may each perform a multiplication operation between input data input thereto and a weight matrix. The types of activation functions included in the MLP 570 are not limited to those described above, and various activation functions such as Sigmoid, Rectified Linear Unit (ReLU), Tanh, Leaky ReLu, Parametric ReLU (PReLU), and Exponential Linear Unit (ELU) may be used.

In an embodiment, the second summation layer 580 may perform an element-wise summation operation between the output data from the first summation layer 550 and output data from the MLP 570. The output data from the second summation layer 580 may be first output data F_{out,3} from the transformer layer 500.

In an embodiment, the transformer layer 500 may output second output data F_{out,4}. The second output data from the transformer layer 500 may be second output data from the patch merging module 540. Because the second input data input to the transformer layer 500 is normalized by the first normalization layer 510 and processed by the patch splitting module 520 and the patch merging module 540, the second output data from the transformer layer 500 may be the same as the normalized first input data input to the transformer layer 500.

FIG. 6 illustrates a first attention module 600 according to an embodiment of the present disclosure.

Referring to FIG. 6, the first attention module 600 may perform attention on a patch-by-patch basis on a plurality of patches 602 into which normalized feature data 601 is split by the patch splitting module 520. For example, first input data F_{in,5} input to the first attention module 600 may be patches obtained by splitting the first feature data xₜ, and second input data F_{in,6} input to the first attention module 600 may be patches obtained by splitting the second feature data xₜ₊ᵢ. In the present disclosure, the first attention module 600 may be referred to as an inter-patch attention module.

Because the patch 602 includes a plurality of pixels, the patch 602 may include structural information such as lines, corners, patterns, etc., which are difficult to identify in individual pixels. When attention is performed on a patch-by-patch basis, a correlation between patches including similar structures may be calculated as a large value, and thus, structural information as well as color information (e.g., pixel intensity) of each pixel may be utilized.

In an embodiment, the first attention module 600 may include a feature warping module 610, a first linear layer 620, a second linear layer 630, a third linear layer 640, a transpose function 650, a first multiplication layer 660, a softmax function 670, a second multiplication layer 680, and a fourth linear layer 690.

In an embodiment, the feature warping module 610 may warp the second input data F_{in,6} input to the first attention module 600, based on bi-directional motion information. Here, the warping may include, but is not limited to, similarity transformation, Euclidean transformation, affine transformation, projective transformation, etc. The feature warping module 610 may perform an operation similar to that of the feature warping module 310 of FIG. 3.

As described above, the feature warping may be performed at any stage before extracting keys and values from the second feature data, so when the multi-frame matching module 300 includes the feature warping module 310, the first attention module 600 may not include the feature warping module 610.

In an embodiment, the first linear layer 620 may obtain a query Q corresponding to the first input data by performing a multiplication operation between the first input data input to the first attention module 600 and a weight matrix included in the first linear layer 620. In an embodiment, the first linear layer 620 may include a 1×1 convolution layer.

In an embodiment, the second linear layer 630 may obtain a key K corresponding to the second input data by performing a multiplication operation between the second input data input to the first attention module 600 (or the second input data warped by the feature warping module 610) and a weight matrix included in the second linear layer 630. In an embodiment, the second linear layer 630 may include a 1×1 convolution layer.

In an embodiment, the third linear layer 640 may obtain a value V corresponding to the second input data by performing a multiplication operation between the second input data input to the first attention module 600 (or the second input data warped by the feature warping module 610) and a weight matrix included in the third linear layer 640. In an embodiment, the third linear layer 640 may include a 1×1 convolution layer.

In an embodiment, the transpose function 650 may transpose the key to generate a transposed key K^{T}.

In an embodiment, the first multiplication layer 660 may perform an element-wise multiplication operation between the query and the transposed key.

In an embodiment, the second multiplication layer 680 may perform an element-wise multiplication operation between the value and an output of the first multiplication layer 660 to which the softmax function 670 is applied. The output of the first multiplication layer 660 to which the softmax function 670 is applied may be understood as a weight representing a correlation between the query and the key, and the operation of the second multiplication layer 670 may be understood as weighted summation of the weight and the value.

In an embodiment, the fourth linear layer 690 may perform a multiplication operation between an output of the second multiplication layer 680 and a weight matrix included in the fourth linear layer 690. In an embodiment, the fourth linear layer 690 may include a 1×1 convolution layer.

FIG. 7 illustrates a second attention module 700 according to an embodiment of the present disclosure.

Referring to FIG. 7, the second attention module 700 may perform attention on a patch-by-patch basis on a plurality of patches 702 into which normalized feature data 701 is split by the patch splitting module 520. For example, first input data F_{in,7} input to the second attention module 700 may be patches obtained by splitting the first feature data xₜ and second input data F_{in,8} input to the second attention module 700 may be patches obtained by splitting the second feature data xₜ₊ᵢ. In the present disclosure, the second attention module 700 may be referred to as an intra-patch attention module.

In an embodiment, the second attention module 700 may include a feature warping module 710, a first linear layer 720, a second linear layer 730, a third linear layer 740, a transpose function 750, a first multiplication layer 760, a softmax function 770, a second multiplication layer 780, and a fourth linear layer 790.

In an embodiment, the feature warping module 710 may warp the second input data F_{in,8} input to the second attention module 700, based on bi-directional motion information. Here, the warping may include, but is not limited to, similarity transformation, Euclidean transformation, affine transformation, projective transformation, etc. The feature warping module 710 may perform an operation similar to that of the feature warping module 310 of FIG. 3.

As described above, the feature warping may be performed at any stage before extracting keys and values from the second feature data, so when the multi-frame matching module 300 includes the feature warping module 310, the second attention module 700 may not include the feature warping module 710.

In an embodiment, the first linear layer 720 may obtain a query Q corresponding to the first input data by performing a multiplication operation between the first input data input to the second attention module 700 and a weight matrix included in the first linear layer 720. In an embodiment, the first linear layer 720 may include a 1×1 convolution layer.

In an embodiment, the second linear layer 730 may obtain a key K corresponding to the second input data by performing a multiplication operation between the second input data input to the second attention module 700 (or the second input data warped by the feature warping module 710) and a weight matrix included in the second linear layer 730. In an embodiment, the second linear layer 730 may include a 1×1 convolution layer.

In an embodiment, the third linear layer 740 may obtain a value V corresponding to the second input data by performing a multiplication operation between the second input data input to the second attention module 700 (or the second input data warped by the feature warping module 710) and a weight matrix included in the third linear layer 740. In an embodiment, the third linear layer 740 may include a 1×1 convolution layer.

In an embodiment, the transpose function 750 may transpose the key to generate a transposed key K^{T}.

In an embodiment, the first multiplication layer 760 may perform an element-wise multiplication operation between the query and the transposed key.

In an embodiment, the second multiplication layer 780 may perform an element-wise multiplication operation between the value and an output of the first multiplication layer 760 to which the softmax function 770 is applied. The output of the first multiplication layer 760 to which the softmax function 770 is applied may be understood as a weight representing a correlation between the query and the key, and the operation of the second multiplication layer 770 may be understood as weighted summation of the weight and the value.

In an embodiment, the fourth linear layer 790 may perform a multiplication operation between an output of the second multiplication layer 780 and a weight matrix included in the fourth linear layer 790. In an embodiment, the fourth linear layer 790 may include a 1×1 convolution layer.

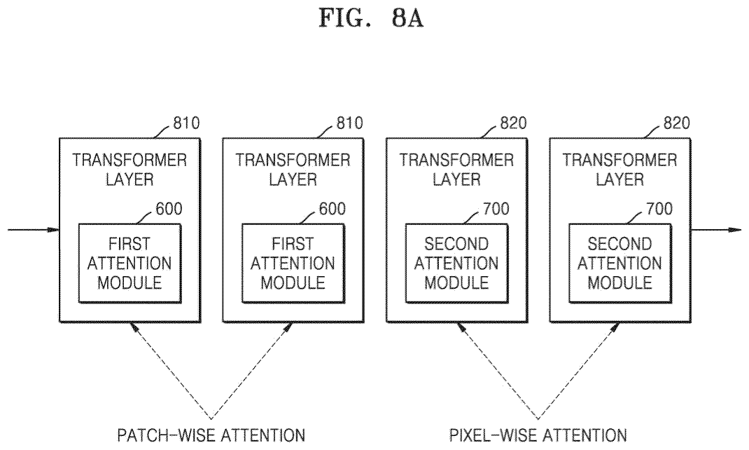

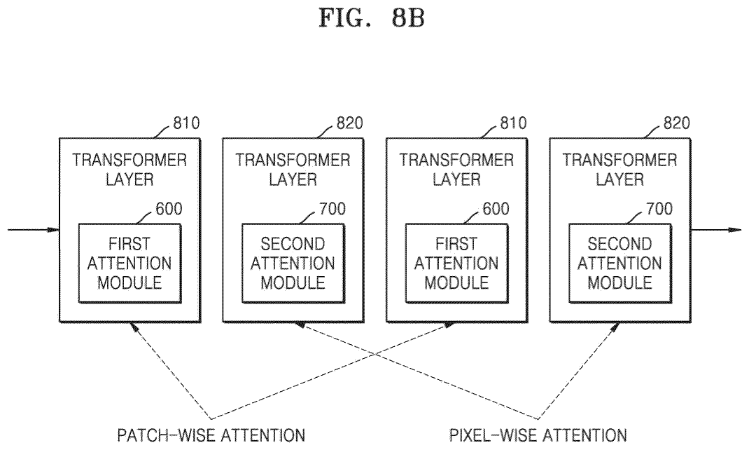

FIGS. 8A and 8B illustrate examples of arrangements of the first attention modules 600 and the second attention modules 700, according to an embodiment of the present disclosure.

FIGS. 8A and 8B are each a simplified diagram illustrating first transformer layers 810 including the first attention modules 600 and second transformer layers 820 including the second attention modules 700. The first transformer layers 810 and the second transformer layers 820 may correspond to the one or more transformer layers 410 illustrated in FIG. 4. In FIGS. 8A and 8B, the four transformer layers 810 and 820 are illustrated for convenience of description, but the number of transformer layers is not limited thereto.

In an embodiment, the number of the first transformer layers 810 and the second transformer layers 820 and the order of arrangement thereof may be implemented in various ways. For example, as illustrated in FIG. 8A, the transformer layers may be arranged in the stated order of the two first transformer layers 810 and the two second transformer layers 820. Alternatively, as illustrated in FIG. 8B, the transformer layers may be arranged so that the first transformer layers 810 and the second transformer layers 820 alternate.

The first transformer layer 810 that performs patch-wise attention may

update the first feature data xₜ by utilizing a wider range of information than the second transformer layer 820. On the other hand, the second transformer layer 820 that performs pixel-wise attention may update the first feature data xₜ by utilizing more detailed information than the first transformer layer 810. Therefore, either the first transformer layer 810 or the second transformer layer 820 may be selected depending on the range of information to be utilized to update the first feature data xₜ. For example, the first transformer layer 810 or the second transformer layer 820 may be selected based on the performance of hardware (e.g., a graphics processing unit (GPU), memory, etc.) performing video processing, a designer's experience, etc.

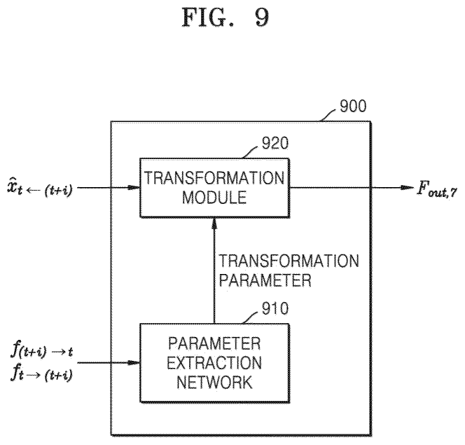

FIG. 9 illustrates a feature transformation module 900 according to an embodiment of the present disclosure.

The feature transformation module 900 illustrated in FIG. 9 may be any one of the feature transformation modules 231, 232, 233, and 234 illustrated in FIG. 2.

Referring to FIG. 9, in an embodiment, the feature transformation module 900 may obtain fourth feature data ƒ_{out,7} by applying feature transformation to third feature data \hat{x}_{t←(t+2)} based on bi-directional motion information ƒ_{t→(t+i)} and ƒ_{(t+i)→t}.

In an embodiment, the feature transformation module 900 may include a parameter extraction network 910 and a transformation module 920.

In an embodiment, the parameter extraction network 910 may obtain transformation parameters based on the bi-directional motion information ƒ_{t→(t+i)} and ƒ_{(t+i)→t}. The transformation parameters are parameters associated with a transformation operation of the transformation module 920, and may include one or more parameters. The parameter extraction network 910 may include one or more artificial neural networks.

In an embodiment, the transformation module 920 may transform the third feature data through a predefined transformation operation based on a transformation parameter. For example, the predefined transformation operation may include, but is not limited to, similarity transformation, Euclidean transformation, affine transformation, projective transformation, etc. For example, the predefined transformation operation may include an operation of multiplying the transformation parameter by the third feature data, or an operation of adding the transformation parameter to the third feature data.

The operation of the feature transformation module 900 described above may be understood as a process of determining the usability of information extracted from a reference frame (e.g., a second frame) by utilizing bi-directional motion information. The bi-directional motion information may be interpreted as a result of matching two frames (e.g., a first frame and a second frame) by taking into account a surrounding area for each pixel. For example, when there is a difference in information between the two frames, such as when an object that exists in the first frame does not exist in the second frame, bi-directional motion information may be calculated inconsistently. The inconsistent bi-directional motion information may imply that the information that differs between the two frames is either very important information or very unimportant information for video processing. The feature transformation module 900 may generate weights (e.g., transformation parameters) to be applied to feature data (e.g., second feature data) extracted from the reference frame via training, and the usability of information extracted from the reference frame may be determined according to the generated weights.

An example of implementation of the feature transformation module 900 is described with reference to FIG. 10.

FIG. 10 illustrates a feature transformation module 1000 according to an embodiment of the present disclosure.

The feature transformation module 1000 illustrated in FIG. 10 is an example of implementation of the feature transformation module 900 illustrated in FIG. 9. A parameter extraction network 1010 and a transformation module 1020 illustrated in FIG. 10 may respectively correspond to the parameter extraction network 910 and the transformation module 920 illustrated in FIG. 9.

Referring to FIG. 10, the parameter extraction network 1010 may include a condition network 1011, first and second convolution layers 1012 and 1013, and third and fourth convolution layers 1014 and 1015.

In an embodiment, the condition network 1011 may obtain intermediate features by performing feature processing on bi-directional motion information. The condition network 1011 may include one or more convolution layers and one or more activation functions. For example, the condition network 1011 may consist of alternating two-dimensional (2D) convolution layers and LeakyReLU activation functions. However, the configuration of the condition network 1011 is not limited thereto. In the present disclosure, the intermediate features may be referred to as a confidence mask.

In an embodiment, the first and second convolution layers 1012 and 1013 may obtain a scale factor by performing a convolution operation on the confidence mask.

In an embodiment, the third and fourth convolution layers 1014 and 1015 may obtain a bias by performing a convolution operation on the confidence mask.

It is described with reference to FIG. 10 that two pairs of convolution layers are used to obtain the scale factor and the bias, respectively, but the type and number of neural networks are not limited thereto.

In an embodiment, the transformation module 1020 may obtain the fourth feature data by multiplying the third feature data by the scale factor and adding the bias to a result of the multiplication.

In the present disclosure, the operation of the feature transformation module 1000 illustrated in FIG. 10 may be referred to as spatial feature transformation.

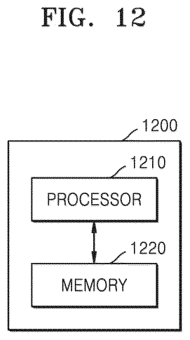

FIG. 11 is a flowchart of a video processing method 1100 according to an embodiment of the present disclosure. The video processing method 1100 may be performed by an electronic device 1200 illustrated in FIG. 12.

In operation 1110, the electronic device 1200 may extract first feature data from a first frame.

In operation 1120, the electronic device 1200 may extract one or more second feature data from one or more second frames.

Operations 1110 and 1120 may correspond to operations of the feature extraction network 110.

In operation 1130, the electronic device 1200 may obtain one or more pieces of bi-directional motion information respectively corresponding to one or more frame pairs. Here, each of the one or more frame pairs may include a first frame and a corresponding second frame among the one or more second frames. Operation 1130 may correspond to an operation of the motion estimation module 120. The bi-directional motion information may include first motion information from the first frame to the second frame, and second motion information from the second frame to the first frame.

In operation 1140, the electronic device 1200 may obtain one or more third feature data by performing first feature processing respectively on one or more feature pairs based on the one or more pieces of bi-directional motion information. Here, each of the one or more feature pairs may include the first feature data and corresponding second feature data among the one or more second feature data. The first feature processing may include attention.

In operation 1150, the electronic device 1200 may obtain one or more fourth feature data by performing second feature processing respectively on the one or more third feature data based on the one or more pieces of bi-directional motion information. The second feature processing may include feature transformation.

In operation 1160, the electronic device 1200 may obtain fifth feature data, based on the first feature data and the one or more fourth feature data.

Operations 1140 to 1160 may correspond to operations of the feature processing network 130.

In operation 1170, the electronic device 1200 may generate a third frame based on the fifth feature data. Operation 1170 may correspond to an operation of the video restoration network 140.

FIG. 12 illustrates the electronic device 1200 for processing a video, according to an embodiment of the present disclosure.

The electronic device 1200 illustrated in FIG. 12 may process a video by performing the operations of the video processing network 100 described above. The video to be processed may be a video stored in the electronic device 1200, or a video received by the electronic device 1200 from an external device (e.g., a server of an over-the-top (OTT) service provider that provides video over the Internet, etc.).

Referring to FIG. 12, in an embodiment, the electronic device 1200 may include a processor 1210 and a memory 1220. However, the components of the electronic device 1200 are not limited thereto, and the electronic device 1200 may include more components than those shown in FIG. 12. For example, the electronic device 1200 may further include a communication interface for transmitting and receiving data to and from an external device, and/or a display for displaying a video.

In an embodiment, the processor 1210 is a component that controls a series of processes to cause the electronic device 1200 to operate as described in the present disclosure, and may consist of one or a plurality of processors. The one or plurality of processors included in the processor 1210 may be circuitry, such as an SoC, an IC, etc. The one or plurality of processors included in the processor 1210 may be a general-purpose processor such as a CPU, an MPU, an AP, a DSP, etc., a dedicated graphics processor such as a GPU and a VPU, a dedicated AI processor such as an NPU, or a dedicated communication processor such as a CP. When the one or the plurality of processors included in the processor 1210 is a dedicated AI processor, the dedicated AI processor may be designed with a hardware structure specialized for processing a particular AI model.

In an embodiment, the processor 1210 may write data to the memory 1220 or read data stored in the memory 1220, and in particular, execute a program or at least one instruction stored in the memory 1220 to process data according to predefined operation rules or AI models. Accordingly, the processor 1210 may perform the operations described in the present disclosure, and the operations described in the present disclosure as being performed by the electronic device 1200 may be considered as being performed by the processor 1210 unless otherwise specifically stated.

In an embodiment, the memory 1220 is a component for storing various programs or data, and may include a storage medium, such as read-only memory (ROM), random access memory (RAM), a hard disk, compact disc ROM (CD-ROM), and a digital versatile disc (DVD), or a combination of storage media. The memory 1220 may not exist separately, but may be configured to be included in the processor 1210. The memory 1220 may consist of volatile memory, non-volatile memory, or a combination of volatile memory and non-volatile memory. The memory 1220 may store a program or at least one instruction for performing operations according to embodiments described in the present disclosure. The memory 1220 may provide stored data to the processor 1210 according to a request from the processor 1210.

According to an aspect of the present disclosure, a method of processing a video may include extracting first feature data from a first frame, extracting one or more second feature data from one or more second frames, obtaining one or more pieces of bi-directional motion information respectively corresponding to one or more frame pairs, wherein each of the one or more frame pairs includes the first frame and a corresponding second frame among the one or more second frames, obtaining one or more third feature data by performing first feature processing respectively on one or more feature pairs based on the one or more pieces of bi-directional motion information, wherein each of the one or more feature pairs includes the first feature data and corresponding second feature data among the one or more second feature data, obtaining one or more fourth feature data by performing second feature processing on the one or more third feature data based on the one or more pieces of bi-directional motion information, obtaining fifth feature data, based on the first feature data and the one or more fourth feature data, and generating a third frame based on the fifth feature data.

In an embodiment, the obtaining of the one or more third feature data by performing the first feature processing respectively on the one or more feature pairs based on the one or more pieces of bi-directional motion information may include warping the one or more second feature data based on the one or more pieces of bi-directional motion information, converting the first feature data and the warped one or more second feature data into patch embeddings, wherein the patch embeddings include first patch embeddings into which the first feature data is converted and second patch embeddings into which the warped one or more second feature data are converted, and the first and second patch embeddings each include a plurality of patches of a predefined size, performing attention on the patch embeddings, and obtaining the one or more third feature data based on a result of the attention.

In an embodiment, the performing of the attention on the patch embeddings may include obtaining a query based on the first patch embeddings, obtaining a key and a value based on the second patch embeddings, calculating a weight based on the query and the key, and applying the weight to the value.

In an embodiment, the performing of the attention on the patch embeddings may include performing first attention on a patch-by-patch basis on a plurality of patches included in the patch embeddings, and performing second attention on a pixel-by-pixel basis on the plurality of patches included in the patch embeddings.

In an embodiment, the obtaining of the one or more fourth feature data by performing the second feature processing on the one or more third feature data based on the one or more pieces of bi-directional motion information may include obtaining one or more transformation parameters based on the one or more pieces of bi-directional motion information, and obtaining the one or more fourth feature data through a predefined transformation operation on the one or more third feature data based on the one or more transformation parameters.

In an embodiment, the one or more transformation parameters may include a scale factor and a bias.

In an embodiment, the predefined transformation operation may include multiplying the one or more third feature data by the scale factor and adding the bias to a result of the multiplication.

In an embodiment, the obtaining of the fifth feature data based on the first feature data and the one or more fourth feature data may include concatenating the one or more fourth feature data, performing a convolution operation on the concatenated one or more fourth feature data, and adding the first feature data to a result of the convolution operation.

In an embodiment, the method may further include obtaining sixth feature data by performing third feature processing on the first feature data, and obtaining the fifth feature data, based on the one or more fourth feature data and the sixth feature data.

In an embodiment, the bi-directional motion information may include first motion information from the first frame to the corresponding second frame, and second motion information from the corresponding second frame to the first frame.

According to an aspect of the present disclosure, a computer-readable recording medium stores one or more instructions which, when executed by a computer, cause the computer to perform a method that may include extracting one or more second feature data from one or more second frames, obtaining one or more pieces of bi-directional motion information respectively corresponding to one or more frame pairs, wherein each of the one or more frame pairs includes the first frame and a corresponding second frame among the one or more second frames, obtaining one or more third feature data by performing first feature processing respectively on one or more feature pairs based on the one or more pieces of bi-directional motion information, wherein each of the one or more feature pairs includes the first feature data and corresponding second feature data among the one or more second feature data, obtaining one or more fourth feature data by performing second feature processing on the one or more third feature data based on the one or more pieces of bi-directional motion information, obtaining fifth feature data, based on the first feature data and the one or more fourth feature data, and generating a third frame based on the fifth feature data.

According to an aspect of the present disclosure, an electronic device 1200 includes at least one processor 1210, and a memory 1220 storing one or more instructions, wherein the at least one processor 1210 is configured to execute the one or more instructions to cause the electronic device 1200 to perform operations that may include extracting one or more second feature data from one or more second frames, obtaining one or more pieces of bi-directional motion information respectively corresponding to one or more frame pairs, wherein each of the one or more frame pairs includes the first frame and a corresponding second frame among the one or more second frames, obtaining one or more third feature data by performing first feature processing respectively on one or more feature pairs based on the one or more pieces of bi-directional motion information, wherein each of the one or more feature pairs includes the first feature data and corresponding second feature data among the one or more second feature data, obtaining one or more fourth feature data by performing second feature processing on the one or more third feature data based on the one or more pieces of bi-directional motion information, obtaining fifth feature data, based on the first feature data and the one or more fourth feature data, and generating a third frame based on the fifth feature data.

In an embodiment, the obtaining of the one or more third feature data by performing the first feature processing respectively on the one or more feature pairs based on the one or more pieces of bi-directional motion information may include warping the one or more second feature data based on the one or more pieces of bi-directional motion information, converting the first feature data and the warped one or more second feature data into patch embeddings, wherein the patch embeddings include first patch embeddings into which the first feature data is converted and second patch embeddings into which the warped one or more second feature data are converted, and the first and second patch embeddings each include a plurality of patches of a predefined size, performing attention on the patch embeddings, and obtaining the one or more third feature data based on a result of the attention.

In an embodiment, the performing of the attention on the patch embeddings may include obtaining a query based on the first patch embeddings, obtaining a key and a value based on the second patch embeddings, calculating a weight based on the query and the key, and applying the weight to the value.

In an embodiment, the performing of the attention on the patch embeddings may include performing first attention on a patch-by-patch basis on a plurality of patches included in the patch embeddings, and performing second attention on a pixel-by-pixel basis on the plurality of patches included in the patch embeddings.

In an embodiment, the obtaining of the one or more fourth feature data by performing the second feature processing on the one or more third feature data based on the one or more pieces of bi-directional motion information may include obtaining one or more transformation parameters based on the one or more pieces of bi-directional motion information, and obtaining the one or more fourth feature data through a predefined transformation operation on the one or more third feature data based on the one or more transformation parameters.

In an embodiment, the one or more transformation parameters may include a scale factor and a bias.

In an embodiment, the predefined transformation operation may include multiplying the one or more third feature data by the scale factor and adding the bias to a result of the multiplication.

In an embodiment, the obtaining of the fifth feature data based on the first feature data and the one or more fourth feature data may include concatenating the one or more fourth feature data, performing a convolution operation on the concatenated one or more fourth feature data, and adding the first feature data to a result of the convolution operation.

In an embodiment, the operations may further include obtaining sixth feature data by performing third feature processing on the first feature data, and obtaining the fifth feature data, based on the one or more fourth feature data and the sixth feature data.

In an embodiment, the bi-directional motion information may include first motion information from the first frame to the corresponding second frame, and second motion information from the corresponding second frame to the first frame.

What is claimed is:

1. A method of processing a video, the method comprising:
obtaining first feature data from a first frame;
obtaining one or more second feature data from one or more second frames;
obtaining one or more pieces of bi-directional motion information respectively corresponding to one or more frame pairs, wherein each of the one or more frame pairs comprises the first frame and a corresponding second frame among the one or more second frames;
obtaining one or more third feature data by performing first feature processing respectively on one or more feature pairs based on the one or more pieces of bi-directional motion information, wherein each of the one or more feature pairs comprises the first feature data and corresponding second feature data among the one or more second feature data;
obtaining one or more fourth feature data by performing second feature processing on the one or more third feature data based on the one or more pieces of bi-directional motion information;
obtaining fifth feature data, based on the first feature data and the one or more fourth feature data; and
generating a third frame based on the fifth feature data.

2. The method of claim 1, wherein the obtaining of the one or more third feature data by performing the first feature processing respectively on the one or more feature pairs based on the one or more pieces of bi-directional motion information comprises:
warping the one or more second feature data based on the one or more pieces of bi-directional motion information;
converting the first feature data and the warped one or more second feature data into patch embeddings, wherein the patch embeddings comprise first patch embeddings into which the first feature data is converted and second patch embeddings into which the warped one or more second feature data are converted, and the first patch embeddings and the second patch embeddings each comprise a plurality of patches of a predefined size;
performing attention on the patch embeddings; and
obtaining the one or more third feature data based on a result of the attention.

3. The method of claim 2, wherein the performing of the attention on the patch embeddings comprises:
obtaining a query based on the first patch embeddings;
obtaining a key and a value based on the second patch embeddings;
calculating a weight based on the query and the key; and
applying the weight to the value.

4. The method of claim 3, wherein the performing of the attention on the patch embeddings comprises:
performing first attention on a patch-by-patch basis on a plurality of patches included in the patch embeddings; and
performing second attention on a pixel-by-pixel basis on the plurality of patches included in the patch embeddings.

5. The method of claim 1, wherein the obtaining of the one or more fourth feature data by performing the second feature processing on the one or more third feature data based on the one or more pieces of bi-directional motion information comprises:
obtaining one or more transformation parameters based on the one or more pieces of bi-directional motion information; and
obtaining the one or more fourth feature data through a predefined transformation operation on the one or more third feature data based on the one or more transformation parameters.

6. The method of claim 5, wherein the one or more transformation parameters comprise a scale factor and a bias, and
the predefined transformation operation comprises multiplying the one or more third feature data by the scale factor and adding the bias to a result of the multiplying.

7. The method of claim 1, further comprising:
obtaining sixth feature data by performing third feature processing on the first feature data; and
obtaining the fifth feature data, based on the one or more fourth feature data and the sixth feature data.

8. A non-transitory computer-readable recording medium storing one or more instructions which, when executed by at least one processor, cause an electronic device to perform operations comprising:
obtaining first feature data from a first frame;
obtaining one or more second feature data from one or more second frames;
obtaining one or more pieces of bi-directional motion information respectively corresponding to one or more frame pairs, wherein each of the one or more frame pairs comprises the first frame and a corresponding second frame among the one or more second frames;
obtaining one or more third feature data by performing first feature processing respectively on one or more feature pairs based on the one or more pieces of bi-directional motion information, wherein each of the one or more feature pairs comprises the first feature data and corresponding second feature data among the one or more second feature data;
obtaining one or more fourth feature data by performing second feature processing on the one or more third feature data based on the one or more pieces of bi-directional motion information;
obtaining fifth feature data, based on the first feature data and the one or more fourth feature data; and
generating a third frame based on the fifth feature data.

9. An electronic device comprising:
at least one processor; and
memory storing one or more instructions,
wherein the one or more instructions, when executed by the at least one processor, cause the electronic device to perform operations comprising:
obtaining first feature data from a first frame,
obtaining one or more second feature data from one or more second frames,
obtaining one or more pieces of bi-directional motion information respectively corresponding to one or more frame pairs, wherein each of the one or more frame pairs comprises the first frame and a corresponding second frame among the one or more second frames,
obtaining one or more third feature data by performing first feature processing respectively on one or more feature pairs based on the one or more pieces of bi-directional motion information, wherein each of the one or more feature pairs comprises the first feature data and corresponding second feature data among the one or more second feature data,
obtaining one or more fourth feature data by performing second feature processing on the one or more third feature data based on the one or more pieces of bi-directional motion information,
obtaining fifth feature data, based on the first feature data and the one or more fourth feature data, and
generating a third frame based on the fifth feature data.

10. The electronic device of claim 9, wherein the obtaining of the one or more third feature data by performing the first feature processing respectively on the one or more feature pairs based on the one or more pieces of bi-directional motion information comprises:
warping the one or more second feature data based on the one or more pieces of bi-directional motion information;
converting the first feature data and the warped one or more second feature data into patch embeddings, wherein the patch embeddings comprise first patch embeddings into which the first feature data is converted and second patch embeddings into which the warped one or more second feature data are converted, and the first patch embeddings and the second patch embeddings each comprise a plurality of patches of a predefined size;
performing attention on the patch embeddings; and
obtaining the one or more third feature data based on a result of the attention.

11. The electronic device of claim 10, wherein the performing of the attention on the patch embeddings comprises:
obtaining a query based on the first patch embeddings;
obtaining a key and a value based on the second patch embeddings;
calculating a weight based on the query and the key; and
applying the weight to the value.

12. The electronic device of claim 11, wherein the performing of the attention on the patch embeddings comprises:
performing first attention on a patch-by-patch basis on a plurality of patches included in the patch embeddings; and
performing second attention on a pixel-by-pixel basis on the plurality of patches included in the patch embeddings.

13. The electronic device of claim 9, wherein the obtaining of the one or more fourth feature data by performing the second feature processing on the one or more third feature data based on the one or more pieces of bi-directional motion information comprises:
obtaining one or more transformation parameters based on the one or more pieces of bi-directional motion information; and
obtaining the one or more fourth feature data through a predefined transformation operation on the one or more third feature data based on the one or more transformation parameters.

14. The electronic device of claim 13, wherein the one or more transformation parameters comprise a scale factor and a bias, and
the predefined transformation operation comprises multiplying the one or more third feature data by the scale factor and adding the bias to a result of the multiplying.

15. The electronic device of claim 9, wherein the operations further comprise:
obtaining sixth feature data by performing third feature processing on the first feature data; and
obtaining the fifth feature data, based on the one or more fourth feature data and the sixth feature data.
